(19) United States
(12) Patent Application Publication
(10) Pub. No.: US 2025/0314280 A1
(43) Pub. Date: Oct. 9, 2025

(54) Tunable Self-Centering Vibration Damping System

(71) Applicant: Dotworkz, Santee, CA (US)

(72) Inventors: Manuel D. Ochoa Ochoa, San Diego, CA (US); Roberto S. Medina, Ontario, CA (US); William Ferris, San Diego, CA (US)

(73) Assignee: Dotworkz, Santee, CA (US)

(21) Appl. No.: 18/629,288

(22) Filed: Apr. 8, 2024

(51) Int. Cl. F16F 7/14

(52) U.S. Cl. CPC F16F 7/14; F16F 2230/0082

(57) ABSTRACT

A tunable, self-centering vibration damping and isolation system for stabilizing vibration-sensitive devices such as cameras and surveillance systems. A lower mounting plate is provided having a plate aperture. An upper plate is provided having an outwardly-depending shaft extending through the plate aperture to receive a camera or surveillance system. The upper plate is offset and flexibly supported above the lower mounting plate by a plurality of wire rope isolator elements and a plurality of elastomer O-ring elements, the properties of each of which are selected based at least in part on a user-defined or predetermined set of vibration displacement, velocity, frequency, or acceleration data. The camera or surveillance system is suspended through the aperture on the terminal end of the shaft so as to be supported on the plurality of wire rope isolator elements and O-ring elements.

### CROSS-REFERENCE TO RELATED APPLICATIONS

N/A

### STATEMENT REGARDING FEDERALLY SPONSORED RESEARCH AND DEVELOPMENT

N/A

### BACKGROUND OF THE INVENTION

### 1. Field of the Invention

The invention relates generally to the field of passive vibration damping and isolation systems.

More specifically, the invention relates to a tunable, self-centering mechanical vibration damping mounting system used to minimize the transmission of external vibration to a device such as a camera or imager.

### 2. Description of the Related Art

Video cameras, and imaging and recording devices have become ubiquitous in the public domain for uses in security, transportation, autonomous vehicles, and monitoring applications along with numerous aerospace, marine, rail and military applications.

Such cameras may be configured for live feed viewing by an operator, or for scene recording or remote viewing after an event occurs by means of transmitting the recorded video data to an off-site operator. Decreasing surveillance camera system and video storage costs, coupled with increasing wireless data transmission bandwidth and advanced optics have contributed to the growing presence of cameras in public and private locations and for use in applications world-wide.

The above video and still-image camera devices are typically mounted in protective housings or enclosures that securely protect the camera system from environmental factors such as rain, snow, fog, environmental contaminants such as dust and soot, or extreme temperatures.

Owing to the robust nature of current surveillance camera systems and housings, video surveillance systems are commonly installed and operated in environments that are subject to numerous sources of mechanical vibration. Such sources may include nearby traffic, low frequency, wind and weather, high-intensity audio sources, vibration of the object to which the housing is attached such as automobile or aircraft, nearby machine introduced or environmentally introduced vibration, or mechanical vibration or shock that is transmitted from a building or structure to a camera housing to which the housing is attached.

The above external vibration may be detrimentally transmitted to the housing, camera and ultimately to the imager array in the camera. Any vibration or jitter of the camera imager within the housing is extremely undesirable in that the recorded image or video becomes blurred approximately proportional to the intensity of any transmitted multi-dimensional vibration, owing to the X, Y, Z physical displacement of the pixel array imager that the vibration introduces.

Any external or environmental vibration is ideally fully damped in a camera system to minimize its negative effects on camera hardware lifespan, image quality and image stabilization algorithm implementation.

Prior art attempts at mechanical vibration damping of a camera system and the reduction of image blur have included software approaches that utilize custom software kernels or algorithms. These approaches have been aimed at minimizing blur in a recorded image data set by using software kernels that analyze and process individual and group pixel data in an effort to extract and render a less blurred final output from the image data. Such approaches are useful but have been found to be insufficient, particularly in applications where significant mechanical vibration is present.

Additional prior art approaches to vibration damping of a camera include the incorporation of one or more mechanical spring or shock absorber elements that are intended to isolate the camera itself from the housing vibration. This lower cost approach is robust and useful for high-displacement vibration damping and typically employs one or more wire rope isolator assemblies that are comprised of braided metal wire rope cable segments in mechanical connection with a plate or base in a radial or linear configuration, whereby the camera is supported or suspended at least in part by the mechanical stiffness of the wire rope isolator elements. The vibration-induced flexure of the wire rope isolator elements dissipates some portion of the external vibration that is transmitted from the environment to the housing and the camera.

In other prior art approaches, rubber or elastomeric elements have been used to function as shock absorbers for the camera, but the respective wire rope isolator element approach and the elastomer element approach has been met with limited success in damping.

A further deficiency in the above prior art approaches is that the wire rope elements and the elastomeric elements in these systems are generally provided as “one size fits all” and have a fixed set of material and mechanical properties. Accordingly, such systems are not adjustable or tunable for a specific set of vibration criteria which may vary dramatically from application to application

What is needed is a robust, low cost, low maintenance, tunable vibration damping and isolation system for a camera mount that improves vibration damping performance beyond that of the above prior art systems.

### BRIEF SUMMARY OF THE INVENTION

In a first embodiment, the invention may comprise a tunable, self-centering vibration damping system having a lower mounting plate and an upper plate configured to receive a vibration-damped element such as a camera. The upper plate is offset and flexibly supported above the lower mounting plate by a plurality of user-defined wire rope isolator elements and a plurality of user-defined elastomer O-ring elements.

In an alternative embodiment, the invention may comprise a self-centering vibration damping system having a lower mounting plate comprising a plate aperture. An upper plate is provided comprising an outwardly-depending shaft extending through the plate aperture to receive a vibration-damped element such as a camera. The upper plate is offset and flexibly supported above the lower mounting plate by a plurality of user-defined wire rope isolator elements and a plurality of user-defined O-ring elements.

The invention may be configured wherein the upper plate is supported above the lower mounting plate by an outer diameter lateral surface of at least one O-ring element.

The invention may be configured wherein a first major surface of at least one O-ring element is angularly disposed at an acute angle with respect to an opposing second major surface of an adjacent O-ring element.

The invention may be configured wherein the angular disposition of the first major surface with respect to the opposing second major surface is about 15 degrees.

The invention may be configured wherein at least one mechanical or material property of the O-ring element, or the wire rope isolator element, or both the O-ring element and the wire rope isolator element, are selected based on a user-defined or predetermined set of vibration data or characteristic including without limitation, vibration displacement, vibration velocity, vibration frequency, or vibration acceleration data or any combination thereof.

The invention may be configured wherein the plurality of the O-ring elements are selected to support about 30% of the weight of the vibration-damped element.

The invention may be configured wherein the plurality of wire rope isolator elements are selected to support about 70% of the weight of the vibration-damped element.

The invention may be configured wherein at least one O-ring element major surface geometry is selected from the group consisting of an oval, elliptical, toroidal, square, rectangular, and quad ring geometry.

The invention may be configured wherein at least one O-ring element comprises a user-defined geometry.

The invention may be configured wherein a cross-section of at least one O-ring element is selected from the group consisting of a circular, square, rectangular, elliptical and oval cross-section.

The invention may be configured such that the radius of the curve of one or more of the wire rope isolator elements is adjustable by means of adjustable set screws and base retaining elements or equivalent structures whereby a user can modify a vibration damping characteristic of the one or more wire rope isolator elements.

The invention may be configured whereby at least one O-ring element is provided with one or more user-defined inwardly-depending projections or one or more user-defined outwardly-depending projections, or both, to define a user-defined mechanical characteristic of the O-ring such as a radial compression characteristic.

The invention may be configured wherein a plurality of sets of O-ring elements and wire rope isolator elements are disposed on an elongate lower mounting plate and an elongate upper plate, in, for instance, a rectangular geometry

These and various additional aspects, embodiments and advantages of the present invention will become apparent to those of ordinary skill in the art upon review of the Detailed Description and the claims that follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 is a top perspective view of the vibration damping system of the invention comprising a vibration damped element such as a camera.

FIG. 2 is an upward facing perspective view of the vibration damping system of the invention comprising a vibration damped element such as a camera.

FIG. 3 is a top perspective view of the vibration damping system of the invention showing a plurality of sets of angularly disposed O-ring elements and a plurality of wire rope isolator elements in a “C” configuration attached to the lower mounting plate by means of a plurality of set screws and base or retaining members.

FIG. 4 is a side view of the vibration damping system of the invention of FIG. 3 showing an outwardly depending shaft of the upper plate extending through a centrally disposed apparatus in the lower mounting plate.

FIG. 5 is a top perspective view of the vibration damping system of the invention showing a plurality of sets of angularly disposed O-ring elements each comprising a plurality of inwardly depending projections and a plurality of outwardly depending projections and a plurality of adjustable wire rope isolator elements in a helical or coiled configuration attached to the lower mounting plate by means of a plurality of set screws and base or retaining members.

FIG. 6 is a side view of the embodiment of FIG. 5.

FIG. 7 is a top plan view of an exemplar O-ring element having a circular major surface geometry and comprising a plurality of inwardly depending projections.

FIG. 8 is a top plan view of an exemplar O-ring element having an elliptical major surface geometry and comprising a plurality of inwardly depending projections and a plurality of outwardly depending projections.

FIG. 9 illustrates a top plan view of an alternative embodiment of the vibration damping system of the invention comprising and elongate upper plate and lower mounting plate and showing a non-limiting orientation of the respective wire rope isolator elements and O-ring elements.

FIGS. 10-A, 10-B and 10-C are plot graphs showing exemplar vibration test table data in the form of X, Y and Z displacement of the vibration table with respect to the vibration damped element 140.

The invention and its various embodiments can now be better understood by turning to the following description of the preferred embodiments which are presented as illustrated examples of the invention in any subsequent claims in any application claiming priority to this application. It is expressly understood that the invention as defined by such claims may be broader than the illustrated embodiments described below.

### DETAILED DESCRIPTION OF THE INVENTION

Applicant discloses a method and device comprising a tunable self-centering vibration damping system for use with a vibration-damped element such as a camera.

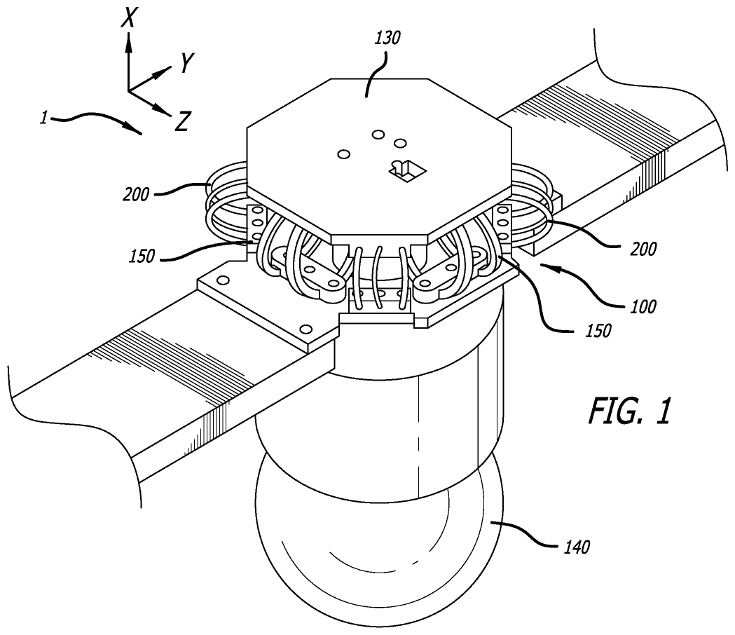

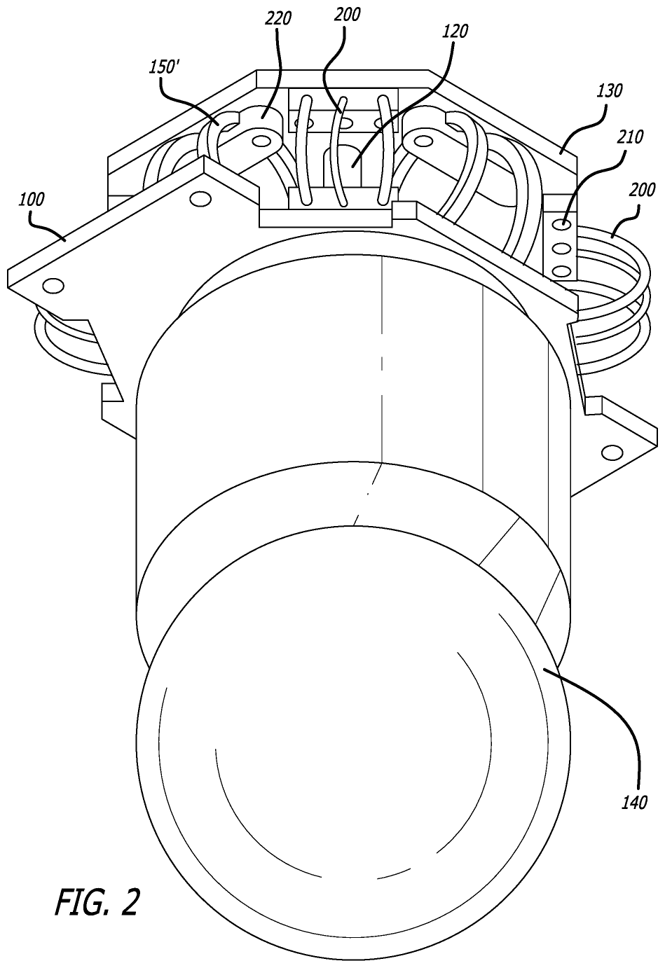

Turning to the figures wherein like numerals denote like elements among the several views, the device of the invention depicted in FIGS. 1 and 2 illustrate a first embodiment of the tunable self-centering vibration damping system 1 of the invention.

Lower mounting plate 100 is configured to be fixedly mounted to the interior of a camera housing, surveillance system mount or similar structure. Lower mounting plate 100 is preferably fabricated from a rigid plastic or metal substrate material suitable for the weight of the system and its intended environment but may be fabricated from any material suitable for the environment and application in which it is to be operated.

In the illustrated embodiment, lower mounting plate 100 comprises an approximately centrally disposed aperture 110 for the receiving of a shaft 120 which outwardly projects and depends from upper plate 130. Shaft 120 may comprise a terminal portion 120′.

Upper plate 130 and shaft 120 are preferably fabricated from a rigid plastic or metal substrate material suitable to bear the weight of the system and its intended environment but may be fabricated from any material suitable for the environment and application in which it is to be operated.

Upper plate 130 is oriented with respect to and supported above lower mounting plate 100 whereby shaft 120 extends and is suspended through aperture 110. The terminal portion 120′ of shaft 120 is suspended and may be configured to fixedly receive a vibration damped element 140 such as a camera.

Vibration damping system 1 may comprise a plurality of elastomer O-ring elements 150. O-ring element 150 comprises an inner diameter 160 and an outer diameter 170 and comprises two major surfaces areas 150″ on opposing sides.

O-ring element 150 may comprise an outer diameter lateral surface or side 180 about outer diameter 170 and an inner diameter lateral surface 190 about its inner diameter 160.

O-ring elements 150 are disposed between upper plate 130 and lower plate 100 whereby a portion of the weight of upper plate 130 and vibration damped element 140 is borne by O-ring elements 150 and exerts a radial compression force about the one or more outer diameter lateral surfaces 180 approximately normal to the axis of inner diameter 160.

O-ring elements 150 are preferably fabricated from an elastomeric compressible material such as PTFE, nitrile (Buna), neoprene, EPDM rubber, fluorocarbon (Viton), silicone rubber, neoprene, AFLAS or polyurethane, but any flexible elastomeric material with suitable chemical and mechanical properties to withstand the environmental factors associated with the intended use of vibration damping system 1 may be used.

At least one physical property of O-ring elements 150, including, without limitation, inner diameter, outer diameter, thickness, material and chemical properties, and geometry of O-ring elements 150, is selected at least in part based on a user-defined or predetermined set of vibration displacement, velocity, frequency and acceleration criteria so as to optimize vibration damping of vibration damped element 140 when operating in the environment in which vibration damping system 1 is used. Current software mechanical modeling tools such as MATLAB may be used to efficiently and accurately mechanical model the final system using user-defined vibration characteristics to select one or more physical properties of O-rings 150.

O-ring elements 150 may be provided with one or more user-defined geometries, including without limitation, an oval, elliptical, toroidal, square, rectangular, and quad ring geometry, and selected based at least in part on a user-defined or predetermined set of vibration displacement, velocity, frequency, and acceleration criteria and are user-selected so as to optimize damping of vibration damped element 140.

The cross-section of O-ring elements 150 may be provided with a user-defined geometry, including without limitation, a circular, square, rectangular, and oval cross-section, and selected at least in part, based on a user-defined or predetermined set of vibration displacement, velocity, frequency, and acceleration criteria so as to optimize damping of vibration damped element 140 when operating in the vibration environment in which vibration damping system 1 will be used.

Upper plate 130 is offset above and flexibly connected to lower mounting plate 100 by a plurality of wire rope isolator elements 200 and the plurality of elastomer O-ring elements 150 whereby upper plate 130, shaft 120 and vibration damped element 140 are permitted to move in multiple dimensions with respect to lower plate 100, which multidimensional movement is restricted by the mechanical properties of the combined plurality of wire rope isolator element 200 and O-ring elements 150.

The physical properties of O-ring elements 150 such as the inner diameter, outer diameter, thickness, material and chemical properties, and geometry of O-ring elements 150, are selected, at least in part, based on a user-defined or predetermined set of vibration displacement, velocity, frequency and acceleration criteria so as to optimize damping of vibration damped element 140 when operating in the vibration environment in which vibration damping system 1 will be used.

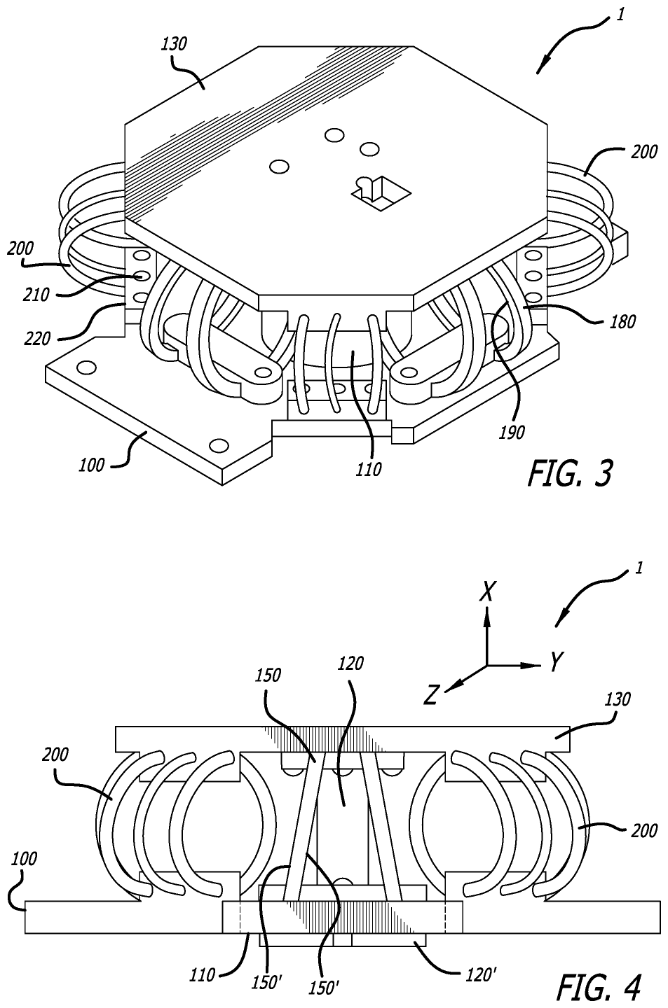

As best seen in FIG. 3 and FIG. 4, vibration damping system 1 may comprise a plurality of wire rope isolator elements 200 which cooperate with O-rings 150 to maximize vibration damping. Wire rope isolator element 200 may comprise a “C” shaped wire rope segment, a circular wire rope segment or both a “C” shaped wire rope segment and a circular wire rope segment.

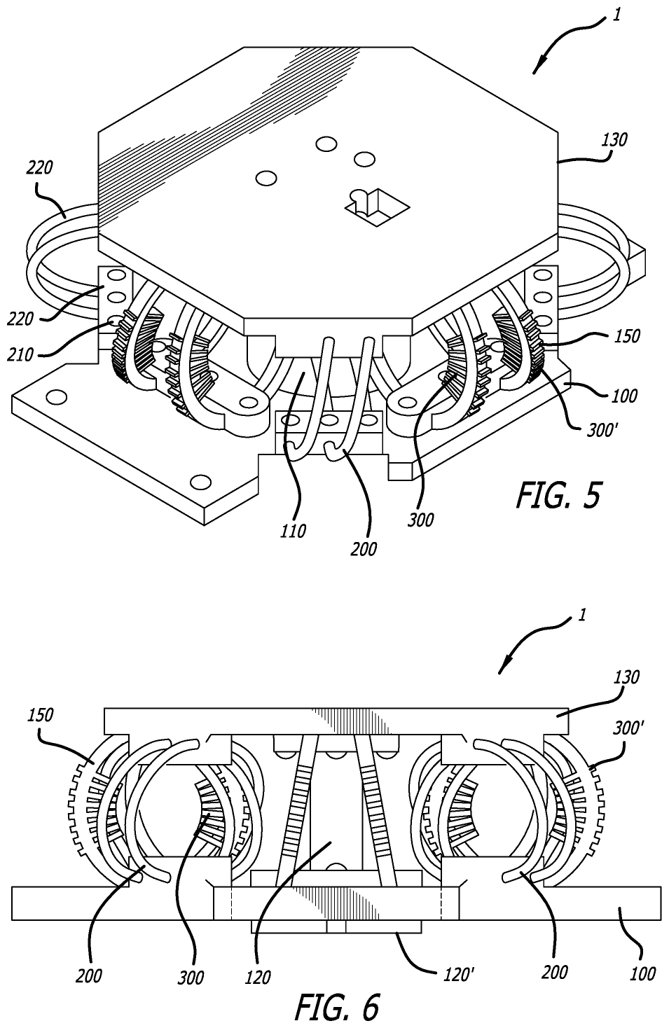

As illustrated in FIG. 5 and FIG. 6, wire rope isolator element 200 may also be provided in a “wound” configuration by means of adjustable set screws 210 and base or retaining members 220 to comprise a coil or helical structure wherein a single wire rope segment is configured to provide a plurality of mechanically independent wire rope loops to function as a plurality of separate wire rope isolator elements 200, each having its own mechanical flexure properties.

One or more adjustable set screws 210 and base or retaining members 220 may be provided whereby a user can selectively adjust and secure the length of the individual wire rope isolator elements 200, and thus vary the radius of same, thereby varying the stiffness and force of each wire rope isolator element 200 to accommodate a predetermined set of vibration displacement, velocity, frequency, and acceleration criteria so as to optimize damping of vibration damped element 140.

The number of and radius of the curvature of the wire rope isolator elements 200 may be based at least in part on based on a user-defined or predetermined set of vibration displacement, velocity, frequency, and acceleration criteria so as to optimize damping of vibration damped element 140 when operating in the vibration environment in which vibration damping system 1 will be used.

Similarly, the mechanical and material properties of the wire rope isolator elements 200 may be based at least in part on a user-defined set of specifications including, without limitation, material, coating, wire strength, flexibility, abrasion resistance, crushing resistance, fatigue resistance, rotation resistance, strand configuration, strand diameter, core geometry and configuration, segment length and diameter, direction and type of lay, finish, grade, and core specifications, which properties may be based at least in part on a user-defined or predetermined set of vibration displacement, velocity, frequency, and acceleration criteria so as to optimize damping of vibration damped element 140 when operating in the vibration environment in which vibration damping system 1 will be used. Current software mechanical modeling tools such as MATLAB may be used to efficiently and accurately mechanically model the final system using user-defined vibration characteristics to select one or more physical properties of wire rope isolator elements 200.

Wire rope isolator elements 200 and O-ring elements 150 are preferably selected whereby about 70% of the combined weight of upper plate 130, shaft 120 and vibration damped element 140 is borne by the plurality of wire rope isolator elements 200 and about 30% of the combined weight of the upper plate 130, shaft 120 and vibration damped element 140 is borne by the plurality of O-ring elements 150.

Upper plate 130 is oriented with respect to lower mounting plate 100 whereby shaft 120 extends through aperture 110 having vibration damped element 140 such as a camera affixed to and suspended from terminal portion 120′.

The combined weight of upper plate 130, shaft 120 and vibration damped element 140 are borne by the combined one or more wire rope isolator elements 200 and one or more O-ring elements 150 in radial compression.

The one or more wire rope isolator elements 200 and one or more O-ring elements 150 are preferably fixedly connected to upper plate 130 and lower mounting plate 100 and are disposed therebetween to permit upper plate 130, shaft 120 and vibration damped element 140 to move with six degrees of freedom. Such X, Y, Z movement is desirably damped and restricted by the combined opposing mechanical forces of the one or more O-ring elements 150 and wire rope isolator elements 200.

O-ring elements 150 are preferably interposed and affixed between upper plate 130 and lower mount plate 100 whereby the major surfaces 150′ of O-ring elements 150 are substantially parallel to the axis of shaft 120. In other words, configured such that the combined weight of upper plate 130, shaft 120 and vibration damped element 140 is borne in part across the diameter of O-ring elements 150 which are in radial compression on their respective opposing outer diameter lateral surfaces 180.

As shown in FIGS. 3-6, in an alternative embodiment, the respective major surfaces 150′ of pairs of adjacent O-ring elements 150 may be angularly disposed with respect to each other at an acute angle, preferably at about 15 degrees but may be disposed at any user-defined angle.

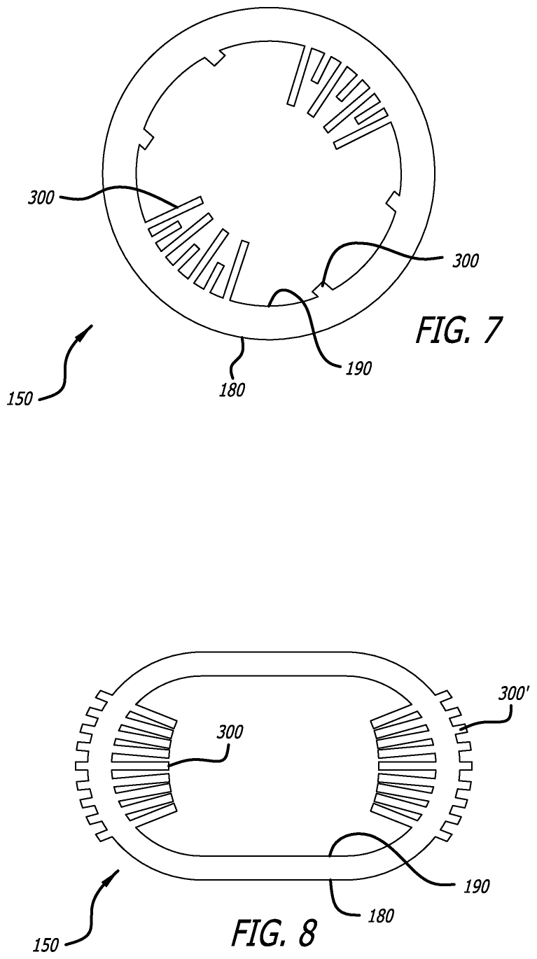

Turning to FIG. 7 and FIG. 8, O-ring elements 150 may be provided with one or more sets of inwardly-depending projections 300 having a predetermined length or set of lengths and geometries whereby a user-defined radial compression characteristic is defined based at least in part on a user-defined or predetermined set of vibration displacement, velocity, frequency, and acceleration criteria so as to optimize damping of vibration damped element 140 when operating in the vibration environment in which vibration damping system 1 will be used.

Similarly, O-ring elements 150 may be provided with one or more sets of outwardly-depending projections 300′ having a predetermined length or set of lengths and geometries whereby a user-defined radial compression characteristic is defined based at least in part on a user-defined or predetermined set of vibration displacement, velocity, frequency, and acceleration criteria so as to optimize damping of vibration damped element 140 when operating in the vibration environment in which vibration damping system 1 will be used.

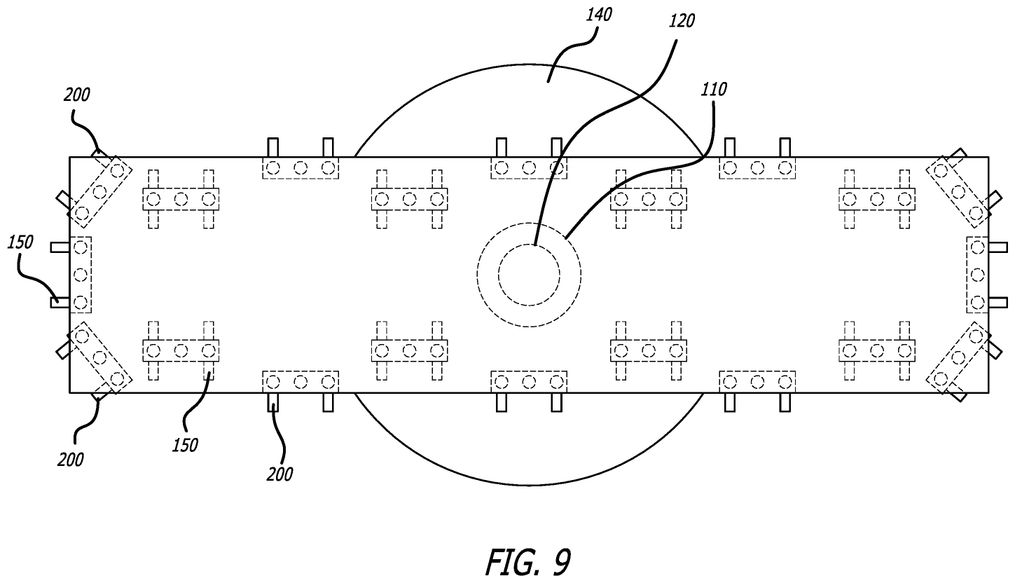

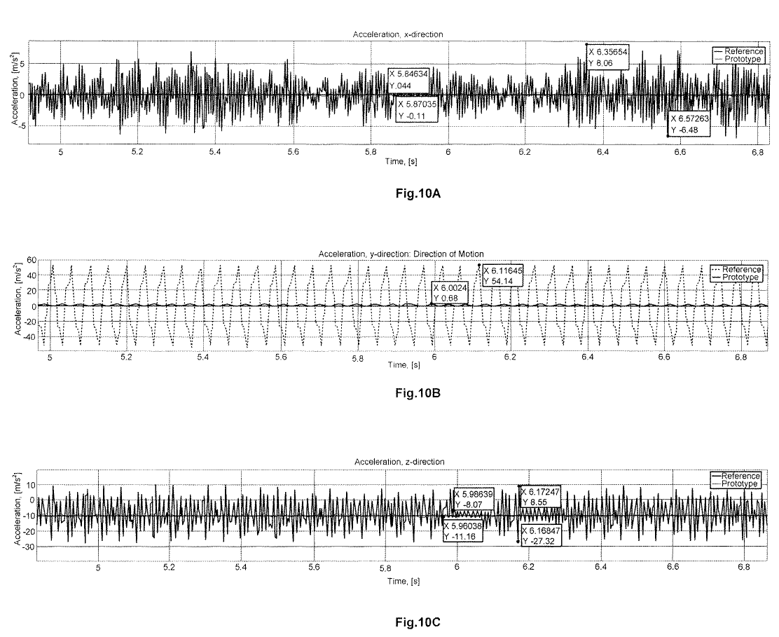

FIG. 9 depicts an alternative embodiment of the invention of vibration damping system 1 wherein a plurality of sets of O-ring elements 150 and wire rope isolator elements 200 are disposed between an elongate lower mounting plate 100 and elongate upper plate 130. While FIG. 9 depicts an elongate lower mounting plate 100 and elongate upper plate 130 in a rectangular geometry, it is expressly noted that the invention is not limited to the illustrated embodiments and that vibration damping system 1 may be instantiated in any desired mounting geometry such as circular, square, rectangle or oval. It is expressly noted that while the illustrated embodiment depict the vibration damping system 1 in a horizontal orientation for mounting within a housing, the final mounted orientation may be in any preferred orientation within a housing or on a mount such as vertically or at a user-desired angle.

It is also expressly noted that the mechanical and material characteristics and geometries of O-rings 150 and wire rope isolator elements 200 need not be identical to the others in a system or even similar, and that each individual or set of the above elements may be uniquely specified to best address and optimize vibration damping based at least in part on a user-defined or predetermined set of vibration displacement, velocity, frequency and acceleration criteria.

Exemplar test vibration damping data is shown in FIG. 10-A, FIG. 10-B and FIG. 10-C and reflects measured vibration table data in the form of X, Y and Z displacement with respect to the vibration damped element 140. The data was acquired by mounting a test mass equal to the weight of an exemplar camera and connecting a first vibration sensor element to the test mass and a second vibration sensor element to the vibration table base.

The vibration input frequency in the illustrated example is about 20.8 Hz and has an amplitude of 1.75 mm of displacement. FIG. 10-1 and FIG. 10-3 depict the forces experienced in the axes perpendicular to the intended motion. FIG. 10-2 illustrates the difference in forces experienced by the vibration table base and test mass in the direction of the input force and shows significantly improved vibration damping performance of vibration damping system 1.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by any claims in any subsequent application claiming priority to this application.

For example, notwithstanding the fact that the elements of such a claim may be set forth in a certain combination, it must be expressly understood that the invention includes other combinations of fewer, more, or different elements, which are disclosed above, even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a subsequent claim must be understood as being generic to all possible meanings supported by the specification and by the word itself.

The definitions of the words or elements of any claims in any subsequent application claiming priority to this application should be, therefore, defined to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements in such claims below or that a single element may be substituted for two or more elements in such a claim.

Although elements may be described above as acting in certain combinations and even subsequently claimed as such, it is to be expressly understood that one or more elements from a claimed combination can in some cases be excised from the combination and that such claimed combination may be directed to a sub-combination or variation of a sub-combination.

Insubstantial changes from any subsequently claimed subject matter as viewed by a person with ordinary skill in the art, now known or later devised, are expressly contemplated as being equivalently within the scope of such claims. Therefore, obvious substitutions now or later known to one with ordinary skill in the art are defined to be within the scope of the defined elements.

Any claims in any subsequent application claiming priority to this application are thus to be understood to include what is specifically illustrated and described above, what is conceptually equivalent, what can be obviously substituted and also what essentially incorporates the essential idea of the invention.

What is claimed:

1. A tunable self-centering vibration damping system comprising:
a lower mounting plate;
an upper plate configured to receive a vibration-damped element;
the upper plate offset and flexibly supported above the lower mounting plate by at least one wire rope isolator element selected based on a user-defined or predetermined vibration displacement, velocity, frequency, or acceleration and at least one O-ring element selected based on the user-defined or predetermined vibration displacement, velocity, frequency, or acceleration.

2. A tunable, self-centering vibration damping system comprising:
a lower mounting plate comprising a plate aperture;
an upper plate comprising an outwardly-depending shaft extending through the plate aperture to receive a vibration-damped element;
the upper plate offset and flexibly supported above the lower mounting plate by a plurality of wire rope isolator elements and a plurality of O-ring elements.

3. The system of claim 1 wherein the upper plate is supported above the lower mounting plate by an outer diameter lateral surface of at least one of the O-ring elements.

4. The system of claim 1 wherein a first major surface area of at least one O-ring element is disposed at an acute angle with respect to an opposing second major surface area of an adjacent O-ring element.

5. The system of claim 4 wherein the acute angle is about 15 degrees.

6. The system of claim 1 wherein at least one mechanical or material property of the O-ring element or at least one mechanical or material property of the wire rope isolator element is selected based on a user-defined or predetermined vibration displacement, velocity, frequency, or acceleration.

7. The system of claim 1 wherein the plurality of O-ring elements is selected to support about 30% of a weight of the vibration-damped element.

8. The system of claim 1 wherein the plurality of wire rope isolator elements is selected to support about 70% of a weight of the vibration-damped element.

9. The system of claim 1 wherein an O-ring element geometry is selected from the group consisting of an oval, elliptical, toroidal, square, rectangular, and quad ring major surface geometry.

10. The system of claim 1 wherein the O-ring element comprises a user-defined geometry determined at least in part by a user-defined or predetermined vibration displacement, velocity, frequency, or acceleration.

11. The system of claim 1 wherein a cross-section of the O-ring element is selected from the group consisting of a circular, square, rectangular, elliptical and oval cross-section.

12. The system of claim 1 wherein an inner diameter lateral surface of at least one O-ring comprises at least one inwardly-depending projection having a user-defined geometry determined at least in part by a user-defined or predetermined vibration displacement, velocity, frequency, or acceleration.

13. The system of claim 1 wherein the outer diameter lateral surface of at least one O-ring comprises at least one outwardly-depending projection having a user-defined geometry determined at least in part by a user-defined or predetermined vibration displacement, velocity, frequency, or acceleration.

14. The system of claim 1 wherein a radius of at least one wire rope isolator element may be varied or adjusted by a user.

15. A method for tuning a vibration damped system comprising the steps of:
providing a tunable self-centering vibration damping system comprising a lower mounting plate;
an upper plate configured to receive a vibration-damped element wherein the upper plate is offset and flexibly supported above the lower mounting plate by at least one wire rope isolator element and at least one O-ring element;
varying a radius of a length of at least one of the wire rope isolator elements wherein the radius is determined at least in part on a user-defined or predetermined vibration displacement, velocity, frequency, or acceleration.

16. The method of claim 15 wherein the wire rope isolator element is provided in a “C” shaped segment.

17. The method of claim 15 wherein the wire rope isolator element is provided in a helical or coiled configuration.

18. The method of claim 15 wherein the wire rope isolator element is provided in a circular configuration.

19. The method of claim 15 wherein the radius is adjustable by means of at least one set screw and at least one base or retaining member.
